(19) United States
(12) Patent Application Publication
(10) Pub. No.: US 2002/0097425 A1
(43) Pub. Date: Jul. 25, 2002

(54) Method and system for printing and updating a features page describing the features of a hardcopy device with that device

(76) Inventors: Kevin A. Owen, Meridian, ID (US); Laura J. Davis, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/767,607

(22) Filed: Jan. 22, 2001

(51) Int. Cl. B41J 1/00; G06F 15/00

(52) U.S. Cl. 358/1.15

(57) ABSTRACT

An electronic document file, known as a Features Page, may be stored in the read-only or static memory of a hardcopy device. At a point of sale, a potential customer can have the hardcopy device print a hardcopy of the Features Page so that the customer has a quick reference to the selling points of the device which can be taken with the customer and referred to at the customer's convenience. The Features Page in the hardcopy device can also be updated to reflect awards and reviews the product has received. The Features Page is updated, for example, by downloading an updated Page from a host system or the Internet.

### FIELD OF THE INVENTION

The present invention relates to the field of hardcopy or printing devices and the sales and marketing of such devices. More specifically, the present invention relates to a “features page” about such hardcopy devices that can be updated as needed and which can be printed by the device on command to provide a ready reference to the advantages of the device to potential customers at sales outlets and trade shows.

### BACKGROUND OF THE INVENTION

Printers and facsimile machines are almost indispensable in the work of a modern office or business. Even small businesses and home offices are usually equipped with printers and facsimile machines. Additionally, there are now multi-function peripherals (“MFPs”) that can function as a printer, a facsimile machine, a photocopier and a scanner. All such devices which can produce a hardcopy or printed output are referred to herein as “hardcopy devices.” Thus, the term “hardcopy device” includes printers, facsimile machines, photocopiers, MFPs and any other device that produces a printed product or hardcopy.

The various features and capabilities of a hardcopy device can vary widely between models and manufacturers. The prices of such devices may also vary widely. Consequently, it becomes a difficult task for a potential customer to identify a hardcopy device that meets his or her particular needs at an appropriate price. If the customer wishes to determine the reliability of a particular hardcopy device, reviews written on the device or awards won by the device, even more time-consuming research is required.

In the past, the informational needs of purchasers of hardcopy devices have been meet almost exclusively by providing knowledgeable salespeople at the point of sale, e.g., a retail outlet or trade show. If a knowledgeable person is at hand, the potential customer's questions about the device can usually be answered by the salesperson. However, if the customer discusses a number of hardcopy devices with one or more salespeople, it may become very difficult for the customer to remember which features, etc. are associated with each device. Additionally, even salespeople knowledgeable about the features of the device may be unaware of the device's performance and durability record or the reviews and awards the device has received.

Moreover, if no such salesperson is present, a chance to connect with the potential customer is lost. The customer is merely able to inspect the device without learning much about its features or history. Some printers are able, on command, to print a sample page that illustrates the quality of the printing or some of the fonts available on the printer. However, such pages provide no information about the features of the device, its awards, history, etc.

Brochures or other product literature may be provided at the point of sale for a hardcopy device to educate potential customers about that product. However, this requires the additional expenses of preparing and printing such literature, coordinating the shipment of the literature to the point of sale, and keeping copies of the literature on hand at the point of sale.

Consequently, there is a need in the art for a method and system of more reliably and readily providing information about a hardcopy device to a potential customer. There is a further need for such a method and system that ensures that such information is complete, current and in a form that the customer can easily retain and refer to later.

### SUMMARY OF THE INVENTION

Accordingly, the present invention is directed to a method and system of providing information about a hardcopy device to a potential customer or other user. The present invention may be embodied and described as a hardcopy device that includes a processor; an image printing unit which is controlled by the processor and fed by a print media supply and handling unit; and a memory unit containing an electronic document file which is retrieved, on command, from the memory by the processor and printed in hardcopy form by the image printing unit. The electronic document file is a document describing the features and selling points of the hardcopy device. The memory unit that contains the electronic document file may be a read-only or static memory.

Preferably, the device also has a user interface unit with which a user can issue the command for the device to print the electronic document file in hardcopy form. The user interface unit may display a menu from which the command is issued in response to selection of a corresponding menu item. Alternatively, there may be a display associated with the device which advertises a specific manipulation of the user interface unit that will issue the command. Finally, the command to print the electronic document file may be issued with a host device connected to the hardcopy device.

With a connection to a host device, an updated electronic document file may be downloaded from the host device to the hardcopy device when needed. The hardcopy device may include a static memory unit in which the updated electronic document file is stored for repeated use.

Additionally or alternatively, the hardcopy device may have an embedded Web browser and a connection to the Internet or Web. In this case, the Web browser may download an updated electronic document file from the Internet or Web. The hardcopy device may also dial directly into a host system to download an update of the electronic document file. Again, the hardcopy device may include a static memory unit in which the updated electronic document file is stored for repeated use.

The present invention also encompasses the methods of making and operating a hardcopy device as described above. For example, the present invention includes a method of advertising the features of a hardcopy device, which hardcopy device includes a processor; an image printing unit which is controlled by the processor and fed by a print media supply and handling unit; and a memory unit containing an electronic document file, where the electronic document file is an electronic document describing features of the hardcopy device. This method is performed by retrieving the electronic document file, on command, from the memory and printing the electronic document file in hardcopy form with the image printing unit.

The present invention also encompasses the computer-readable instructions or software required to cause a hardcopy device to operate in the manner described above. Specifically, the present invention encompasses computer-readable instructions stored on a medium for storing computer-readable instructions, where the instructions cause a hardcopy device to implement a method of advertising the features of the hardcopy device, which hardcopy device includes a processor; an image printing unit which is controlled by the processor and fed by a print media supply and handling unit; and a memory unit containing an electronic document file, wherein the electronic document file is an electronic document describing features of the hardcopy device, where the instructions cause the hardcopy device to retrieve the electronic document file, on command, from the memory and print the electronic document file in hardcopy form with the image printing unit.

### BRIEF DESCRIPTION OF THE DRAWINGS

The accompanying drawings illustrate the present invention and are a part of the specification. Together with the following description, the drawings demonstrate and explain the principles of the present invention.

FIG. 1 is a diagram of a hardcopy device according to the present invention.

FIG. 2 is a flowchart of a method of operating such a hardcopy device according to the principles of the present invention.

FIG. 3a is a diagram of a hardcopy device according to the present invention which is connected to a host device.

FIG. 3b is a flowchart of a method of operating the hardcopy device of the present invention shown in FIG. 3a.

FIG. 4 is a diagram of hardcopy device according to a second embodiment of the present invention.

FIGS. 5a and 5b are a flowchart of a method of operating a hardcopy device as shown in FIG. 4 according to the principles of the present invention.

FIG. 6 is a block diagram of a facsimile machine according to the present invention.

### DETAILED DESCRIPTION OF THE PREFERRED EMBODIMENTS

As described above, the present invention relates to an improved means of providing information about a hardcopy device to potential customers. As used herein the term “hardcopy device” includes printers, facsimile machines, photocopiers, multi-function peripherals (“MFPs”) and any other device that produces a printed product or hardcopy.

The term “print media” will be used to refer generally to all media that might be printed on by a hardcopy device. For example, “print media” means, but is not limited to, paper, cardstock, transparencies, envelopes, labels, films, etc.

Under the principles of the present invention, the hardcopy device has stored, in a memory unit thereof, a “Features Page” that can be printed on command. The Features Page provides an exposition of the features of the hardcopy device and any other information that the manufacturer would wish to convey to a potential customer. For example, the Features Page can preferably be updated to describe such aspects of the device as the awards and positive reviews the device has received.

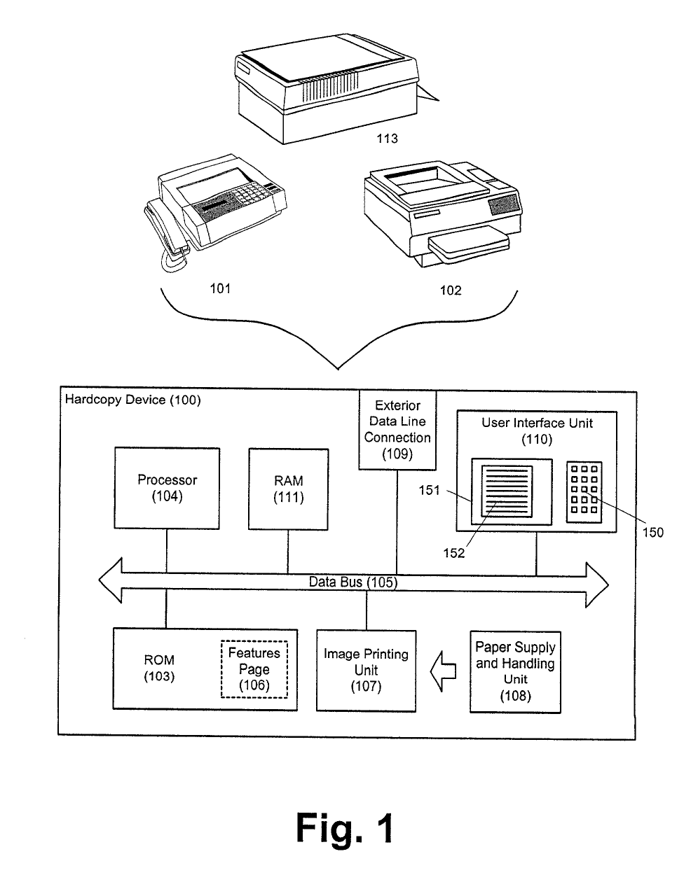

Using the drawings, the preferred embodiments of the present invention will now be explained. FIG. 1 illustrates a generalized block diagram (100) of a hardcopy device according to the present invention. As shown in FIG. 1, this generalized diagram (100) may represent most any hardcopy device according to the principles of the present invention, for example, a facsimile machine (101), a printer or MFP (102), or a photocopier (113).

As shown in FIG. 1, the hardcopy device (100) of the present invention includes a processor (104), a read-only memory (“ROM”) (103) and a random-access memory (“RAM”) (111). The processor (104) may be, but is not limited to, a microprocessor, controller, microcontroller or Application Specific Integrated Circuit (ASIC). The processor (104) controls the operation of the hardcopy device (100) according to programming preferably stored in the ROM (103). This programming is read from the ROM (103) into the RAM (111) for execution by the processor (104).

The hardcopy device (100) will also have an image printing unit (107) which is fed print media by a print media supply and handling unit (108). Under the control of the processor (104), the image printing unit (107) will print and output the hardcopy product of the device (100) based on image data sent to or generated by the hardcopy device (100).

The hardcopy device (100) may also include an exterior data line connection (109). In the case of a printer or MFP (102) this connection (109) may be to a host computer or network of printer clients. In the case of a facsimile machine (101), the exterior data line connection (109) may be a modem connected to a phone line. In the case of a photocopier, the device (100) may or may not have an exterior data line connection (109).

The hardcopy device (100) also preferably includes a user interface unit (110). The user interface unit (110) may include a display device (151) and one or more user input devices, such as a keypad (150). With the user interface (110), the user can receive information about the device (100) and enter commands to the device (100).

A data bus (105) connects and provides communication between the various electronic components of the hardcopy device (100).

Under the principles of the present invention, a “Features Page” (106) is stored in the ROM (103) of the hardcopy device (100). As described above, this Features Page (106) is an electronic document file that can be retrieved and printed by the hardcopy device (100). The Features Page (106) may be one or more pages that describe the features of the hardcopy device (100). For example, the Features Page (106) may include a graphic or photograph of the device (100), list the important features of the device (100), its price, etc. The Features Page (106) may also provide a universal resource locator (URL) or phone number at which additional information about the device (100) can be had or at which an order for the device (100) can be placed. In short, any information that a manufacturer may wish to convey to a potential customer can be included in the Features Page (106) of the present invention.

With the Features Page (106) present in the memory (103) of the hardcopy device (100), the device (100) can be made to retrieve and print the Features Page (106) on command by potential customers. Consequently, if the hardcopy device (100) is displayed at a point of sale such as a retail establishment, a trade show or the like, and a knowledgeable salesperson is not present when the device (100) is inspected by a potential customer, signage or other displays posted with the device (100) can instruct the customer how to retrieve and print the Features Page (106) so as to provide the customer with quick and accurate information about the device (100) which can be taken with the potential customer and referred to later.

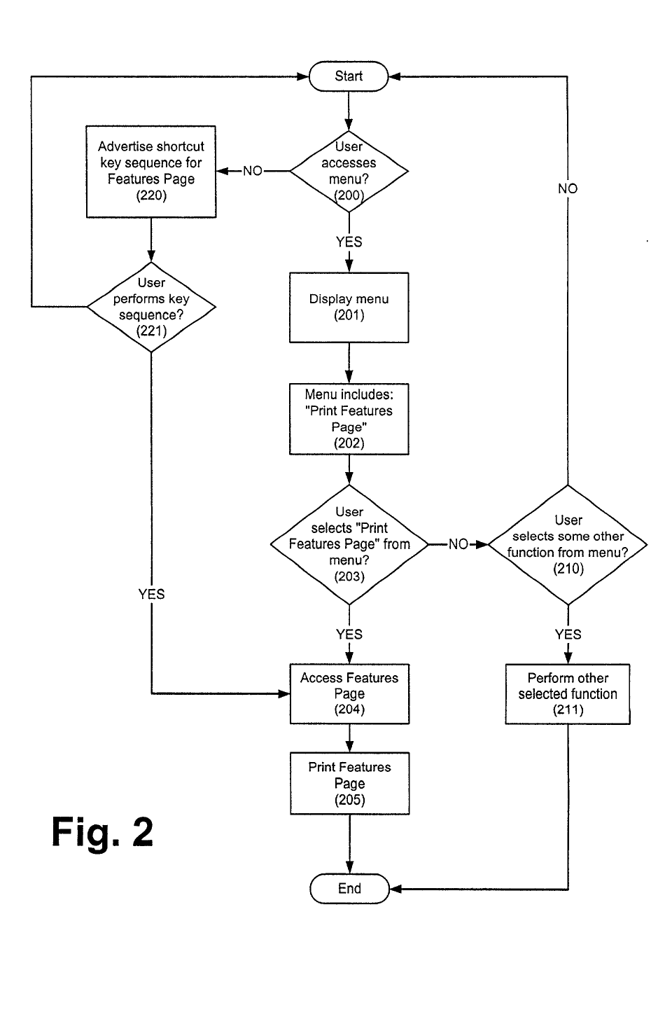

FIG. 2 illustrates a first method that can be used to cause the hardcopy device (100) to retrieve and print the Features Page (106). If the user interface (110) of the hardcopy device (100) includes a display (151), that display (151) can be used to display a menu (152) of features or operations the device (100) can perform. This menu (152) can include an entry that causes the hardcopy device (100) to retrieve and print the Features Page (106). Consequently, as shown in FIG. 2, the user may access the device's control menu using the user interface (200). If the user does so, the interface will display the menu (201), which includes the “PRINT FEATURES PAGE” option (202).

The user may select the “PRINT FEATURES PAGE” option or some other function listed in the menu (203, 210). If the user selects some other function (210), the device (100) will perform that function (211). If the user selects the “PRINT FEATURES PAGE” option (203), the device will access the Features Page (204) and print the Features Page (205).

If the hardcopy device (100) does not have a user interface with such a menu-driven display, there may be a short key sequence or other manipulation of the user interface that will cause the device (100) to retrieve and print the Features Page. For example, the shortcut manipulation may be the simultaneous or sequential pressing of two keys of a keypad, or the pressing of a dedicated “Feature Page” key. If this is the case, signage or some display at the point of sale can be placed with the device (100) to advertise the shortcut key sequence or other manipulation of the user interface that will produce the Features Page (220). The user may then perform the advertised shortcut (221) which will result in the retrieval (204) and printing (205) of the Features Page.

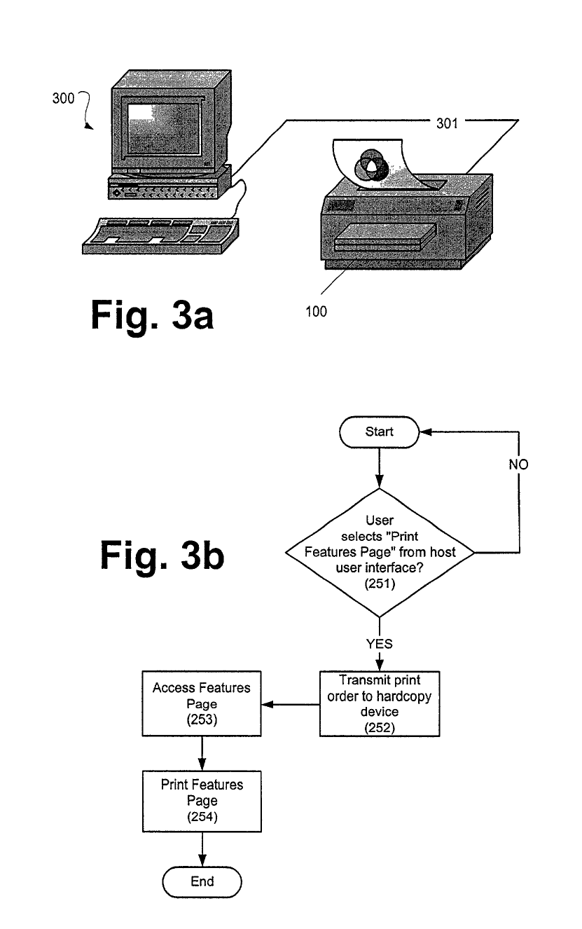

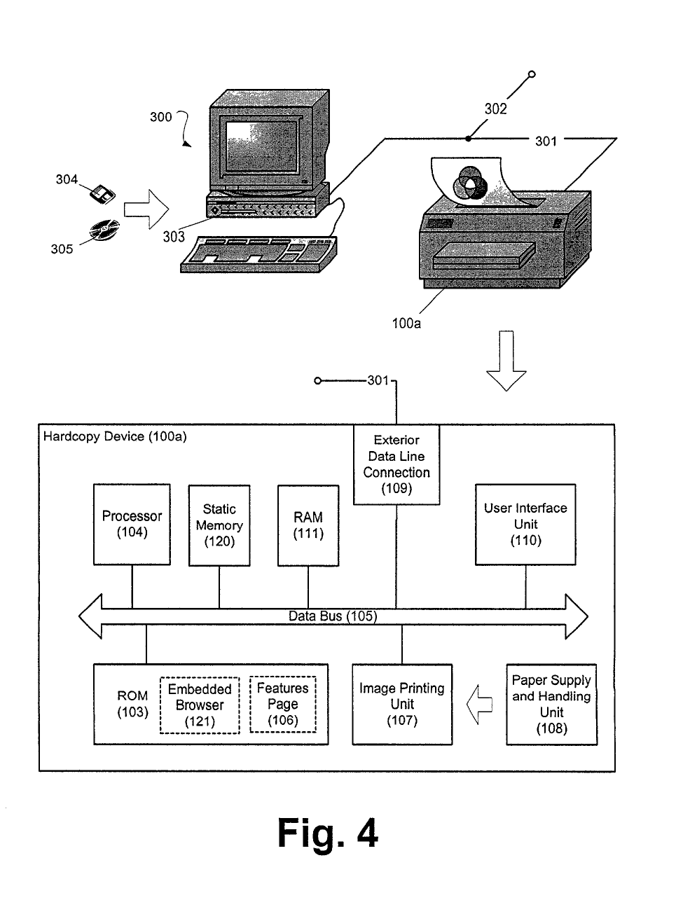

FIG. 3a illustrates that the hardcopy device (100), particularly a printer or MFP, may be connected to a host computer (300). The connection (301) may be any type of data line including, but not limited to, a direct serial or parallel connection, an Ethernet, a Local Area Network (LAN), a wide area network (WAN), a phone line or other data carrying connection.

A hardcopy device (100) may be so connected to a host computer (300) at a point of sale in order to better demonstrate the full features and capabilities of the device (100). If the hardcopy device (100) is connected to a host computer (300), the host computer (300) can be used to send a command to the device (100) to print the Features Page.

This method is illustrated in FIG. 3b. As shown in FIG. 3b, the user may select a “Print Features Page” option (251) in the user interface of the host computer (300). Upon such a selection in the user interface of the host (300), the host will transmit a command (252) to the device (100) via the connection (301) to print the Features Page. This command is preferably an SNMP (Simple Network Management Protocol) object. The device (100) will then access the Features Page (253) and print the Features Page (254).

An important aspect of the Features Page of the present invention is the ability to advise potential customers of such things as the awards, positive reviews and durability record of the hardcopy device. However, such information is infrequently available at the time the hardcopy device is first produced and shipped and the Features Page is stored in the ROM unit (103) of the device (100).

Rather, awards, positive reviews and a good durability record are only garnered after the device (100) has been in production and marketed for some time. Consequently, it becomes important to be able to update the Features Page output by the device (100) as such additional selling points become available.

Updating the Features Page (106) in ROM (103) would require a revision of the tools used to produce the ROM (103) so as to produce a new release of the device (100) with a different ROM (103) containing the updated Features Page (106). Due to the expense involved in making such changes to the manufacturing process, it is unlikely that such a change would be undertaken for the sole purpose of updating the Features Page (106). Consequently, the present invention provides a number of alternative means of updating the Features Page available to the hardcopy device.

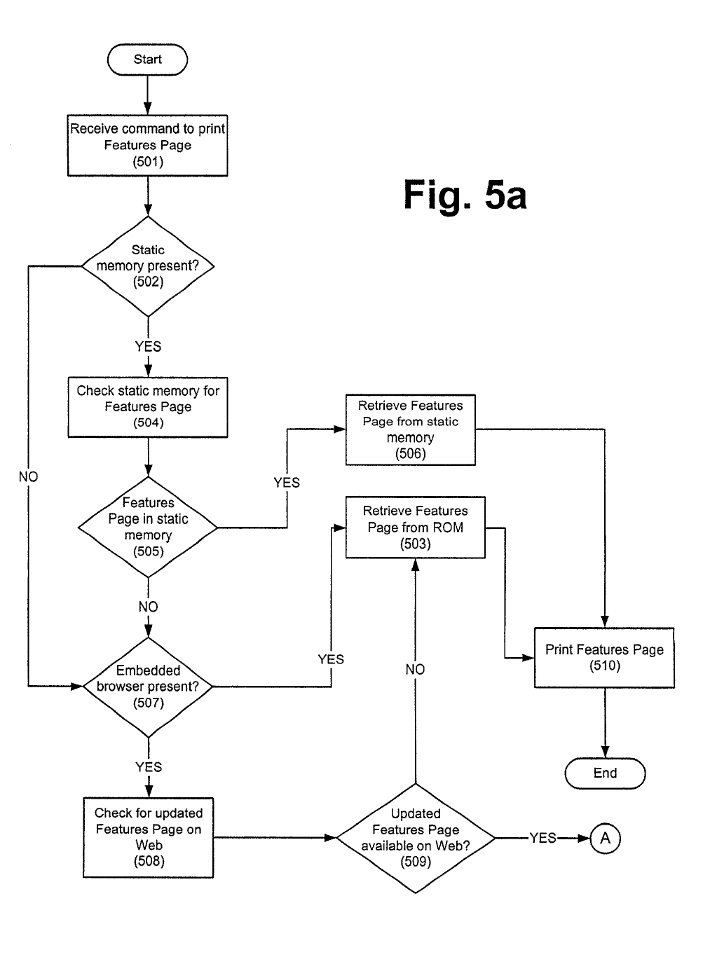

FIG. 4 illustrates some of the methods of providing an alternative means of updating the Features Page available to the hardcopy device according to the present invention. FIG. 4 illustrates a second embodiment of a hardcopy device (100a) according to the present invention. The hardcopy device (100a) is substantially similar to the first hardcopy device (100) described above. Throughout the drawings, identical reference numbers are used to indicate identical elements. Consequently, a redundant explanation of elements already described will be omitted.

As shown in FIG. 4, the hardcopy device (100a) preferably includes an embedded web browser (121) stored in ROM (103). This web browser (121) can be executed by the processor (104) to browse and download information from the Internet or World Wide Web (the “Web”). Consequently, for the embedded browser (121) to be useful, the hardcopy device (100a) must have a connection (302) to the Internet or World Wide Web. Given the embedded browser (121) and the connection (302), the hardcopy device (100a) can download an updated Features Page from the Internet or World Wide Web.

As will be described below, the device (100a) may download an updated Features Page from the Internet whenever requested to print the Features Page and the connection to the Internet is available.

Alternatively, the device (100a) may include a static memory unit (120) in which the updated Features Page is stored for future use. The static memory unit (102) may be, but is not limited to, a hard drive, a flash memory or other static memory device.

If the hardcopy device (100a) is connected to a host computer (300), the host computer (300) can also be used to provide an updated Features Page to the device (100) via the connection (301). If the hardcopy device (100a) includes a static memory unit (120), the updated Features Page can be stored in the static memory for future use regardless of whether the hardcopy device (100a) is still connected to the host (300).

As shown in FIG. 4, a floppy disk (304) or a CD-ROM (305) may be inserted in host. An updated Features Page is stored on the floppy disk (304) or CD-ROM (305) and can be read into the host (300) using a corresponding disk drive (303). The host (300) can then download the updated Features Page to the hardcopy device (100a) for output as a printed Features Page or storage in the static memory (120), if present.

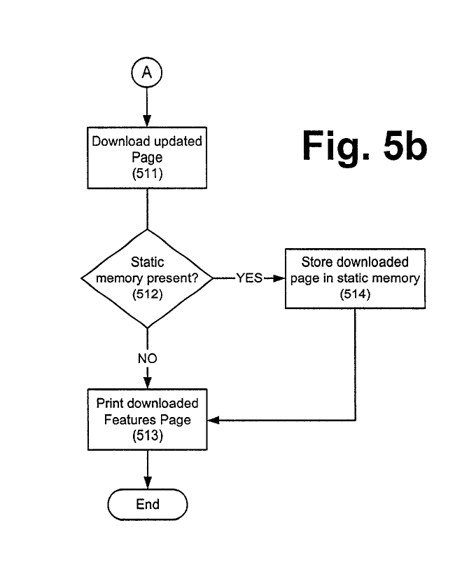

FIGS. 5a and 5b provide a flowchart illustrating these methods of updating the Features Page in a hardcopy device of the present invention. As shown in FIG. 5a, the method starts when the device (100a) receives a command to print the Features Page (501). This command may come from the user interface (110) of the device (100a) or from a connected host.

The device (100a) first determines if a static memory unit is present in the device (502). If there is a static memory unit, the device (100a) will check that static memory for an updated Features Page (504). If an updated Features Page is found in the static memory (505), it is retrieved (506) and printed (510).

If there is no static memory unit present, or if the static memory does not contain an updated Features Page, the device (100a) next determines if an embedded browser and connection to the Internet are available (507). If so, the device (100a) will check for an updated Features Page available on the Web (508).

If no updated Features Page is available on the Web, or if no embedded browser and Internet access are available, the device (100a) will access (503) and print (510) the original Features Page stored in ROM. As will be understood by those skilled in the art, each file of a Features Page may have a date or version number associated therewith so that the device (100a) can determine the most updated Features Page available.

FIG. 5b continues the method illustrated in FIG. 5a in the eventuality that an updated Features Page is identified as available on the Web. The device (100a) will then download the updated Features Page from the Web (511). If static memory is available (512), the updated page may be stored in static memory (514). In any event, the downloaded page is then printed (513) in response to the user's command to produce a Features Page.

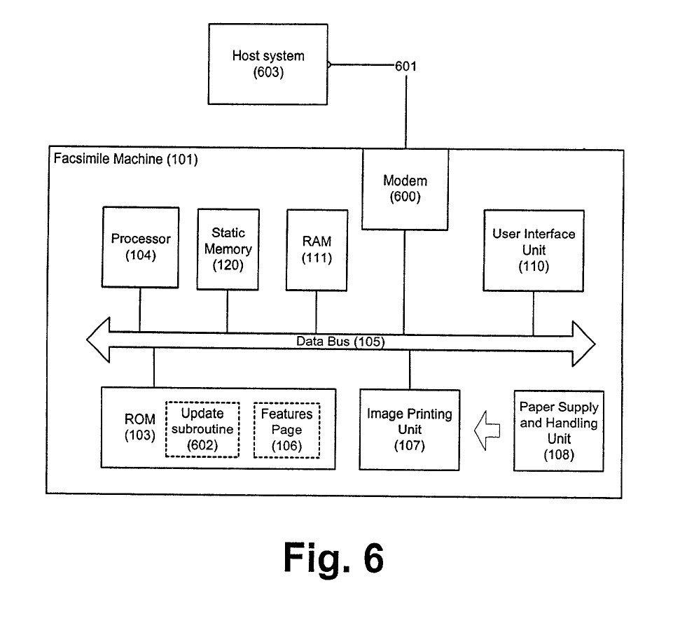

FIG. 6 illustrates a facsimile or fax machine (101) according to the present invention and will be used to describe a means of updating a Features Page stored in the fax machine (101). As shown in FIG. 6, the fax machine (101) preferably includes a static memory unit (120) into which an updated Features Page can be stored. As with the other hardcopy devices described herein, the fax machine (101) also includes a Features Page (106) in ROM (103) that can be retrieved and printed upon entry of a command using, for example, the user interface unit (110).

The fax machine (101) also includes a modem (600) connected to a phone line (601). If the fax machine (101) is connected to a phone line (601), the user may input a command using the user interface unit (110). This command causes the fax machine (101) to seek to update its Features Page.

When the update command is entered, the fax machine (101) will access and execute an update subroutine (602) stored in ROM (103). The update subroutine (602) will cause the fax machine (101) to place a call using the modem (600) and phone line (601) to a pre-programmed number which connects to a host system (603) maintained by the manufacturer. When calling this number, the fax machine (101) will be connected to the manufacturer's system (603) from which an updated Features Page, if available, can be downloaded to the fax machine (101) and stored in static memory (120). In this way, the Features Page for the fax machine can be readily updated as needed. Execution of the update subroutine can be initiated by the command described above, or may be automatic in response to certain criteria such as the passage of a pre-determined period of time, powering up of the fax machine, etc.

The present invention also encompasses the computer-readable instructions, e.g., software, required to make the various hardcopy devices and host computers perform in the manner described herein. As used herein, the term software or computer-readable instructions means any such instructions regardless of the language in which written or the level at which written (e.g., source code, object code, etc.). The flowcharts and supporting text herein outline, describe and define a preferred embodiment of the software which is a part of the present invention.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A hardcopy device comprising:
a processor;
an image printing unit which is controlled by said processor and fed by a print media supply and handling unit; and
a memory unit containing an electronic document file which is retrieved, on command, from said memory by said processor and printed in hardcopy form by said image printing unit;
wherein said electronic document file is a document describing features of said hardcopy device.

2. The device of claim 1, wherein said memory unit is a read-only memory unit and contains said electronic document file.

3. The device of claim 1, further comprising a user interface unit with which a user can issue a command for said device to print said electronic document file in hardcopy form.

4. The device of claim 3, wherein said user interface unit displays a menu from which said command is issued in response to selection of a corresponding menu item.

5. The device of claim 3, further comprising a display associated with said device which advertises a specific manipulation of said user interface device that will issue said command.

6. The device of claim 1, further comprising a connection to a host device, wherein said host device issues said command to print said electronic document file.

7. The device of claim 1, further comprising a connection to a host device, wherein an updated electronic document file is downloaded from said host device to said hardcopy device.

8. The device of claim 1, farther comprising a static memory unit in which said updated electronic document file is stored.

9. The device of claim 1, further comprising an embedded Web browser and a connection to the Internet or Web, wherein said Web browser downloads an updated electronic document file from the Internet or Web.

10. The device of claim 1, further comprising a static memory unit in which said updated electronic document file is stored.

11. The device of claim 1, wherein said hardcopy device is a facsimile machine further comprising a modem and connection to a phone line.

12. The device of claim 11, wherein said facsimile machine further comprises an update subroutine which causes said facsimile machine to connect via said phone line to a host system from which an updated electronic document file is downloaded.

13. A method of advertising the features of a hardcopy device, which hardcopy device includes a processor; an image printing unit which is controlled by said processor and fed by a print media supply and handling unit; and a memory unit containing an electronic document file, wherein said electronic document file is an electronic document describing features of said hardcopy device, said method comprising retrieving said electronic document file, on command, from said memory and printing said electronic document file in hardcopy form with said image printing unit.

14. The method of claim 13, further comprising issuing said command for said device to print said electronic document file in hardcopy form with a user interface unit of said hardcopy device.

15. The method of claim 14, further comprising associating a display with said device which advertises a specific manipulation of said user interface device that will issue said command.

16. The method of claim 13, further comprising displaying a menu from which said command is issued in response to selection of a corresponding menu item.

17. The method of claim 13, further downloading an updated electronic document file from a host device connected to said hardcopy device.

18. The method of claim 13, further comprising downloading an updated electronic document file from the Internet or Web using an embedded Web browser in said hardcopy device and a connection from said hardcopy device to the Internet or Web.

19. The method of claim 13, wherein said hardcopy device is a facsimile machine further comprising a modem and connection to a phone line, said method further comprising connecting said facsimile machine via said phone line to a host system; and downloading an updated electronic document file from said host system.

20. Computer-readable instructions stored on a medium for storing computer-readable instructions, wherein said instructions cause a hardcopy device to implement a method of advertising the features of said hardcopy device, which hardcopy device includes a processor; an image printing unit which is controlled by said processor and fed by a print media supply and handling unit; and a memory unit containing an electronic document file, wherein said electronic document file is an electronic document describing features of said hardcopy device, wherein said instructions cause said hardcopy device to retrieve said electronic document file, on command, from said memory and print said electronic document file in hardcopy form with said image printing unit.
